(19) United States
(12) Patent Application Publication
(10) Pub. No.: US 2022/0168967 A1
(43) Pub. Date: Jun. 2, 2022

(54) WELDING UNIT

(71) Applicant: CLOSAC AG, Grabs (CH)

(72) Inventors: Christian FREI, Oberriet (CH); Remo JUD, Gonten (CH); Marcel KILGA, Hohenems (AT)

(21) Appl. No.: 17/594,022

(22) PCT Filed: Apr. 9, 2020
(86) PCT No.: PCT/EP2020/060290

§ 371 Date: Sep. 30, 2021

(30) Foreign Application Priority Data
Apr. 12, 2019 (DE) 10 2019 109 686.3

(51) Int. Cl. B29C 65/00; B29C 65/18; B29C 65/78

(52) U.S. Cl. CPC B29C 66/4312; B29C 65/18; B29C 65/7891; B29C 66/849; B29C 66/8161; B29C 66/822; B29C 66/83221; B29C 66/81419

(57) ABSTRACT

A welding unit (1) for the thermal welding of film tubes, in particular for a waterless toilet, is proposed, at least two welding means (2, 2a) which can be moved relative to one another being comprised for the thermal welding of a film tube, each welding means (2, 2a) being configured to be movable by means of at least one joint arrangement (3, 3a), the at least one joint arrangement (3, 3a) comprising at least one articulated lever (4, 4a-4e).

### CROSS-REFERENCES TO RELATED APPLICATIONS

This Application is a Section 371 National Stage Application of International Application No. PCT/EP2020/060290, filed Apr. 9, 2020, and published as WO/2020/208211 A1 on Oct. 15, 2020, and claims priority to German Application No. 102019109686.3, filed Apr. 12, 2019, the contents of both are hereby incorporated by reference in their entirety.

### BRIEF DESCRIPTION OF THE DRAWINGS

FIG. 1 shows a greatly simplified schematic illustration of a detail of a welding unit according to the invention;

FIG. 2 shows a greatly simplified schematic illustration of a development of the welding unit shown in FIG. 1;

FIG. 3 shows the welding unit shown in FIG. 2 in a different position;

FIG. 4a shows a greatly simplified schematic side view of a welding unit according to the invention in a first position;

FIG. 4b shows a greatly simplified schematic side view of a welding unit according to the invention in a second position;

FIG. 4c shows a greatly simplified schematic side view of a welding unit according to the invention in a third position;

FIG. 4d shows a greatly simplified schematic side view of a welding unit according to the invention in a fourth position.

### DETAILED DESCRIPTION OF THE DRAWINGS

The invention relates to a welding unit for the thermal welding of film tubes, in particular for a waterless toilet, according to the preamble of claim 1 and to a waterless toilet as claimed in claim 12.

Waterless toilets and welding units therefor for the welding of corresponding film tubes are already known from the prior art. CH 581 462 A5 discloses a system whose tube store is assigned a pair of spreading fingers over which the tube withdrawn from the store is guided.

A particular disadvantage here is that the known welding units have a linear profile of the welding means, as a result of which the welding jaws can only be brought together very slowly. The welding of a film tube, filled with fecal matter, of the waterless toilet is correspondingly slow. In addition, the film can be removed from the welding bar after welding only with difficulty and, in the worst case, may be welded to the subsequent bag.

It is an object of the invention to provide a welding unit, in particular for a waterless toilet, by means of which the welding of film tubes can be carried out reliably and quickly.

The invention is based on a welding unit for the thermal welding of film tubes, in particular for a waterless toilet, at least two welding means which can be moved relative to one another being comprised for the thermal welding of a film tube.

In order to achieve the object, a proposal essential to the invention is that each welding means is configured to be movable by means of at least one joint arrangement, the at least one joint arrangement comprising at least one articulated lever.

This non-linear movement of the welding means enables the welding means to be moved more quickly, and thus faster welding of the film tube. The faster movement can also be understood from a shortening of the route as a result of the arrangement of the welding means on articulated levers.

Articulated levers, especially in the form of toggle joints, have the property that, with increasing extension of the lever joint until the articulated levers enclose an angle of 180° and thus have reached the so-called dead center, said articulated levers can execute a rapid movement with a controlled end position.

In an advantageous refinement of the invention, provision may be made for each joint arrangement to comprise at least one electric drive in order to move the welding means.

This makes it possible to enable direct control and automation of the movement of the welding means by means of a simple construction. Electric motors may be attached as direct drives, in particular synchronized direct drives, or additionally via gear mechanisms and transmissions, so that the necessary force for the movement is achieved.

In a further advantageous refinement of the invention, provision may be made for the joint arrangements to each be operatively connected to the electric drive by means of at least one gearwheel.

This makes it possible to provide efficient power transmission to the welding means via the articulated levers, as a result of which it is in particular possible to enable film tubes to be reliably welded. Moreover, gearwheels permit the direct implementation of a step-up or step-down transmission ratio of an output shaft of the drive and, moreover, allow a compact design through the meshing of the drive train.

In order to be able to achieve a further improvement of the welding result through targeted welding means, in a further very advantageous refinement of the invention, provision may be made for at least one guide means, which preferably comprises at least one slotted guide, to be comprised in order to guide the welding means.

The slotted guide guides the moving components precisely, especially on the side, and is able to absorb any forces which would possibly otherwise act as transverse forces on the joint arrangements. This improves the process reliability and stability of the arrangement.

A particularly good welding result can also be achieved by a development of the invention in that there are two joint arrangements which are arranged mirror-symmetrically with respect to one another, each joint arrangement comprising at least two, preferably three, articulated levers and the articulated levers of each joint arrangement being arranged in each case on a common shaft.

The symmetry of the arrangement allows the welding process to be carried out reliably in the central region of the arrangement, which among other things also reduces the distances to be overcome by the welding means and thus increases the speed of the process.

In order to be able to enable efficient transport of a film tube, in a further refinement of the invention, provision may be made for a transport arrangement to be comprised in order to transport a film tube which is to be welded and/or which has been welded.

In this case, the transport arrangement is preferably arranged at least partially in the course of the film tube above the welding means or below the welding means or on both sides (top and bottom) of the welding means.

In particular, the arrangement of a transport arrangement below the film tube, or at least the attachment of transport means below the film tube, affords the advantage that the welding jaws can be retracted after the welding process has ended, and the transport means above and/or below the welding jaws holds the film tube in place. This prevents sticking to the welding means, since the film is peeled off from them.

To this end, provision is furthermore made for the joint arrangements, in particular the articulated levers, to move the transport means in an offset manner, preferably so as to trail the welding means and/or so as to be decoupled from the welding means.

In order to further improve the transport of a film tube, in a further advantageous refinement of the invention, provision may be made for the transport arrangement to be of two-part design and to comprise a first transport means and a second transport means, the first transport means comprising at least one roller element and the second transport means comprising at least one roller element, the first transport means and the second transport means being movable relative to one another by means of at least one electric drive, preferably by means of two electric drives, in order to transport the film tube.

Transport means that are separate from one another allow uniform, mutual gripping of the film tube and improve transport in terms of speed, guidance and reliability, for example in the case of kinks and overlapping layers.

The transport of a film tube can be further improved by virtue of the transport means each comprising a plurality of, preferably between two and six, roller elements which are spaced apart from one another.

The roller elements offer the film tube sufficient surface adhesion, and allow the system of the transported film tube to form free, relaxed regions between the roller elements, which increases the process reliability during transport.

One refinement of the invention may provide that the first transport means and the second transport means are each operatively connected to a respective electric drive by means of at least one gearwheel and the respective one electric drive is preferably operatively connected to a respective joint arrangement. This makes it possible to provide efficient power transmission to the transport means, as a result of which reliable transport of a film tube can be made possible.

In one advantageous refinement, the invention may also provide that each transport means comprises in each case at least one angled retaining means, the angled retaining means of the transport means being arranged mirror-symmetrically with respect to one another. In this way, an enlarged space between two transport means can be obtained. This can have an advantageous effect on the reception capacity of the film tube with respect to fecal matter and can thus also enable improved user-friendliness for a user.

Furthermore, in one advantageous refinement of the invention, provision may be made for the first transport means and the second transport means to each be arranged so as to be movable along the guide means, the guide means being of substantially dumbbell-shaped configuration and having a greater height at its respective end sections compared to a central section.

This makes it possible for each transport unit to be able to be driven out, so to speak, as a result of which an enlarged space between two transport means can be obtainable. This can have an advantageous effect on the reception capacity of the film tube with respect to fecal matter and can thus also enable improved user-friendliness for a user.

In a development of the invention, provision may be made for at least one spring means to be comprised, which is operatively connected to at least one welding means in order to generate a contact pressure on the film tube.

The use of a spring means makes it possible to achieve a situation whereby the contact pressure on the film tube during the welding process is not achieved and/or supported by the articulated levers themselves, but by the spring action. As a result, it is not necessary, for example, to overextend the articulated levers, in particular beyond the dead center, or the application and holding of the contact pressure by the drives does not necessarily have to be provided. This may save costs when dimensioning the drives.

The welding result can be significantly improved by a contact pressure of the welding means on the film tube that is further increased due to the spring action.

A further improvement of the welding result can be obtainable in that at least two spring means are comprised, each welding means being operatively connected to at least one of the at least two spring means, the at least two spring means being configured as similar or different types of spring means. In this way, the symmetry of the force action can be improved.

With regard to the improvement of the welding result, it is also advantageous if the at least one spring means is configured as a tension spring or as a compression spring.

The invention also relates to a waterless toilet, comprising a welding unit for closing film tubes, the welding unit being configured as claimed in one of claims 1 to 11.

Such a toilet is characterized in particular in that a film tube filled with fecal matter is welded quickly and reliably.

What is also claimed is a waterless toilet with a welding unit for closing film tubes, the welding unit being configured as claimed in one of the claims mentioned, in particular according to one of the embodiments set out above.

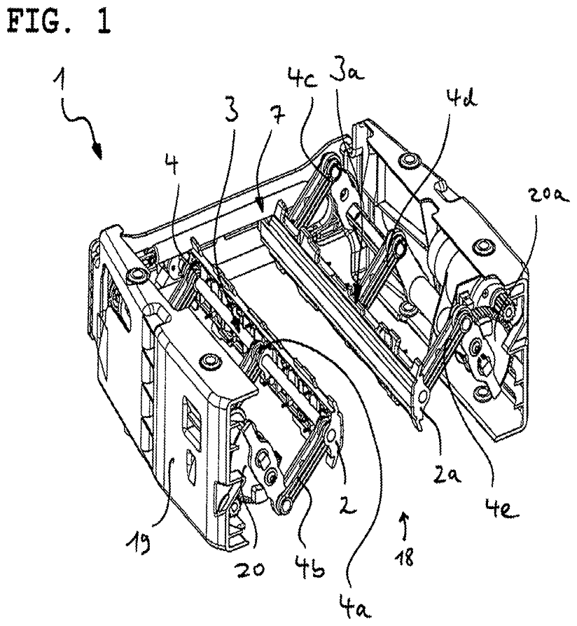

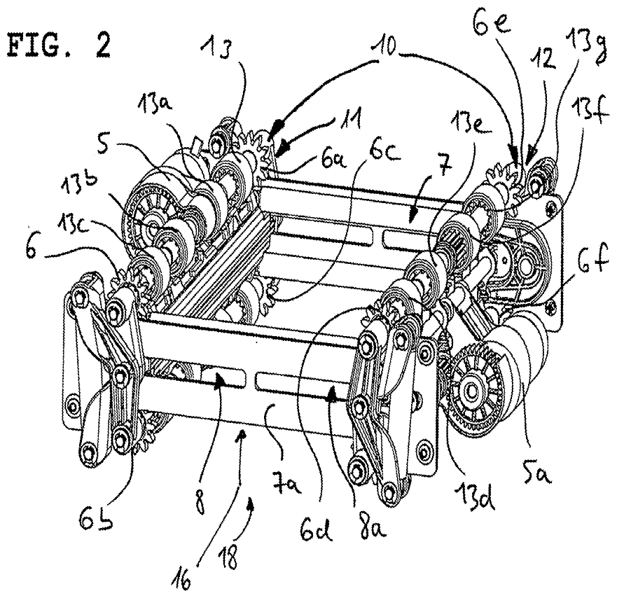

FIG. 1 shows a greatly simplified schematic illustration of a detail of a welding unit 1 according to the invention. For better understanding, a front viewing side 18 is left open in the figure. A guide means 7a is preferably arranged correspondingly to FIG. 2.

The welding unit 1 shown in FIG. 1 is shown in a position which can be regarded as a rest position.

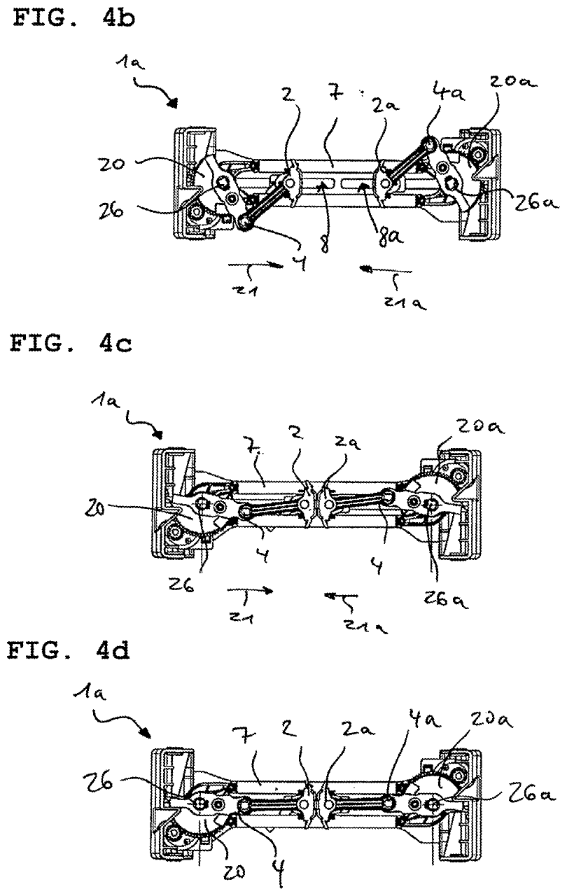

The sequence when welding a film tube can be seen in more detail in FIGS. 4a to 4d.

The welding unit 1 as per FIG. 1 is provided for the thermal welding of film tubes, in particular for a waterless toilet (not shown), two welding means 2, 2a which can be moved relative to one another being comprised for the thermal welding of a film tube.

Each welding means 2, 2a is configured to be movable by means of a joint arrangement 3, 3a, the at least one joint arrangement 3, 3a comprising at least one articulated lever 4, 4a-4e.

In the present case, each joint arrangement 3, 3a comprises a plurality of, namely three, articulated levers 4, 4a-4e in each case.

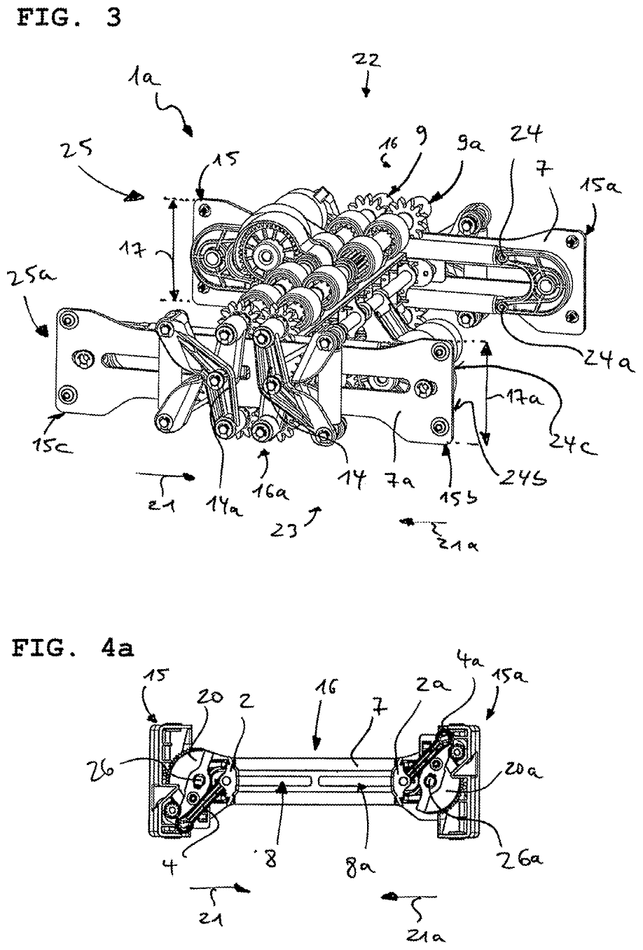

Each joint arrangement 3, 3a comprises an electric drive 5, 5a for movement purposes (see FIG. 2 and FIG. 3).

The welding unit 1 can optionally comprise a frame 19. For reasons of a simplified illustration, such a frame is not shown in FIG. 2 and; but can nevertheless be comprised in a corresponding manner.

In the refinement of the welding unit 1a as per FIG. 2, a transport arrangement 10 is additionally comprised, this being provided in order to transport a film tube which is to be welded and/or which has been welded, said film tube not being shown in any more detail.

The transport arrangement 10 according to the exemplary embodiment (FIG. 2) is of two-part design and comprises a first transport means 11 and a second transport means 12. In this case, the first transport means 11 comprises roller elements 13-13c comprises and the second transport means 12 roller elements 13d-13g. The first transport means 11 and the second transport means 12 can be moved relative to one another by means of a respective electric drive 5, 5a, that is to say by means of two electric drives, in order to transport the film tube, which is not illustrated in any more detail. This relative movability can also be seen in FIG. 3, in which the transport means 11, 12 are illustrated, so to speak, in the brought-together state.

In the embodiment of the welding unit 1a according to FIG. 2 or according to FIG. 3, the transport means 11, 12 each comprise a plurality of roller elements 13-13g which are spaced apart from one another.

The first transport means 11 and the second transport means 12 are each operatively connected to a respective electric drive 5, 5a (see, for example, FIG. 2) by means of gearwheels 20, 20a (see, for example, FIG. 1, FIG. 4a). The respective one electric drive 5, 5a is operatively connected to a respective joint arrangement 3, 3a via corresponding gearwheel arrangements.

Furthermore, each transport means 11, 12 comprises in each case angled retaining means 14, 14a. The angled retaining means 14, 14a (see, for example, FIG. 3) of the transport means 11, 12 are arranged mirror-symmetrically with respect to one another.

In the exemplary embodiment according to FIG. 1 or FIG. 2, the first transport means 11 and the second transport means 12 are each arranged so as to be movable along the guide means 7, 7a. The guide means 7, 7a is of substantially dumbbell-shaped configuration has a greater height 17, 17a at its respective end sections 15, 15a, 15b, 15c compared to a central section 16, 16a (see also FIG. 4a).

As per FIG. 2, a plurality of gearwheels 6, 6a-e are comprised. The main purpose of the gearwheels 6, 6a-e is to transport a film tube. When the transport means 11, 12 are being brought together along directions of movement 21, 21a (see also FIG. 3 and FIG. 4a), the gearwheels mesh and the rotary movement for transporting the film or transporting the film tube is transmitted to the counter roller, i.e. transport unit.

Therefore, in a particularly advantageous refinement of the invention, provision may be made for only one drive per transport means 11, 12 to be provided. This can mean a considerable simplification of the construction of the welding unit 1, 1a.

If the film were to stick to the welding means 2, 2a, the tensile force to release it is also guaranteed on account of the gearwheels.

Although a plurality of gearwheels 6, 6a-e are shown in the figures, provision may be made in one refinement of the invention for the number of gearwheels to be amount to four, these gearwheels, which are only installed on one side, in such a way that a respective pair is provided for the top, that is to say on a top side 22, and the bottom, that is to say on a bottom side 23.

Correspondingly to the refinements as per FIG. 1 and FIG. 2, the welding unit 1, 1a comprises guide means 7, 7a in order to guide the welding means 2, 2a. The guide means 7, 7a each comprise a slotted guide 8, 8a (see, for example, FIG. 2 and FIG. 4a).

In order to weld a film tube filled with fecal matter (not shown) by means of the welding unit 1, 1a, welding means 2, 2a (see, for example, FIG. 4a) are moved relative to one another in each case along directions of movement 21, 21a until they are brought together (FIG. 4d). The thermal welding of a film tube can be effected in this brought-together position. It can be seen in FIG. 4d that the articulated levers are extended up to shortly before their dead center, since those articulated points of the articulated levers 4 and 4a which face away from the welding means 2, 2a do not lie on a line. Movement up to dead center or even exceedance thereof would cause a noise, up to and including a sudden impulse in the system, since the contact pressure is at its maximum at dead center. This may possibly be perceived as unpleasant or faulty.

In this case, the movement of the welding means 2, 2a does not take place linearly, but by means of articulated levers 4, 4a (see, for example, FIG. 4a to FIG. 4d) which are comprised by a joint arrangement (see FIG. 1).

Due to the joint-like movement of the welding means 2, 2a, their travel route can be reduced or accelerated in relation to a linear movement. In this way, the welding operation for closing a film tube can be accelerated accordingly.

The joint-like movement can moreover also be provided for the transport arrangement 10 (see FIG. 2). The advantages mentioned above apply analogously.

In a further possibility (not illustrated in any more detail), provision may also be made within the scope of the invention for the joint arrangement or the corresponding articulated levers to be configured to be movable beyond their respective dead center or to be moved beyond a respective dead center.

FIG. 3 shows that spring means 24, 24a, 24b, 24c are comprised, which is operatively connected to welding means 2, 2a in order to generate a contact pressure on the film tube (not shown).

Since the structure of the welding unit 1 is symmetrical, spring means act on both welding means.

It may be possible for spring means to be operatively connected to welding means via axles 26, 26a (see, for example, FIGS. 4a, 4b, 4c, 4d) of the gearwheels 20, 20a.

In addition or as an alternative, it may be possible for spring means to be operatively connected to welding means via articulated levers 4, 4a-e.

In a manner not shown in any more detail, it may also be possible for only one spring means to be comprised which is operatively connected to a welding means in order to generate a contact pressure on the film tube.

Spring means 24, 24a, 24b, 24c may be designed as tension springs or as compression springs (not shown).

It may also be possible for a plurality of spring means to be present, spring means embodied as tension springs and compression springs being present (not shown).

In the shown exemplary embodiment as per FIG. 3, a plurality of spring means 24, 24a, 24b, 24c are comprised. In this case, each welding means is operatively connected to spring means. For reasons of a simplified illustration, only spring means 24, 24a of the component element 25 (FIG. 3) and spring means 24b, 24c of the component element 25a (FIG. 3) are illustrated. These are operatively connected to welding means 2 (see, in this regard, FIG. 1); however, further spring means (not illustrated) are possible and in particular provided with regard to the mirror-symmetrically arranged component elements 25, 25a and in particular also to welding means 2.

In the exemplary embodiment shown, the spring means 24, 24a, 24b, 24c are configured as similar spring means. In a manner not shown in any more detail, it may also be possible for various types of spring means, for example compression springs and tension springs, to be present.

Although the present invention has been described with reference to preferred embodiments, workers skilled in the art will recognize that changes may be made in form and detail without departing from the spirit and scope of the invention.

List of reference designations:

| | |
|---|---|
| 1 | Welding unit |
| 1a | Welding unit |
| 2 | Welding means |
| 2a | Welding means |
| 3 | Joint arrangement |
| 3a | Joint arrangement |
| 4 | Articulated lever |
| 4a | Articulated lever |
| 4b | Articulated lever |
| 4c | Articulated lever |
| 4d | Articulated lever |
| 4e | Articulated lever |
| 5 | Drive |
| 5a | Drive |
| 6 | Gearwheel |
| 6a | Gearwheel |
| 6b | Gearwheel |
| 6c | Gearwheel |
| 6d | Gearwheel |
| 6e | Gearwheel |
| 6f | Gearwheel |
| 7 | Guide means |
| 7a | Guide means |
| 8 | Slotted guide |
| 8a | Slotted guide |
| 9 | Shaft |
| 9a | Shaft |
| 10 | Transport arrangement |
| 11 | First transport means |
| 12 | Second transport means |
| 13 | Roller element |
| 13a | Roller element |
| 13b | Roller element |
| 13c | Roller element |
| 13d | Roller element |
| 13e | Roller element |
| 13f | Roller element |
| 13g | Roller element |
| 14 | Retaining means |
| 14a | Retaining means |
| 15 | End section |
| 15a | End section |
| 15b | End section |
| 15c | End section |
| 16 | Central section |
| 16a | Central section |
| 17 | Height |
| 17a | Height |
| 18 | Front viewing side |
| 19 | Frame |
| 20 | Gearwheel |
| 20a | Gearwheel |
| 21 | Direction of movement |
| 21a | Direction of movement |
| 22 | Top side |
| 23 | Bottom side |
| 24 | Spring means |
| 24a | Spring means |
| 24b | Spring means |
| 24c | Spring means |
| 25 | Component element |
| 25a | Component element |
| 26 | Axle |
| 26a | Axle |

1. A welding unit for the thermal welding of film tubes, in particular for a waterless toilet, at least two welding means which can be moved relative to one another being comprised for the thermal welding of a film tube, wherein
each welding means is configured to be movable by means of at least one joint arrangement, the at least one joint arrangement comprising at least one articulated lever.

2. The welding unit of claim 1, wherein each joint arrangement comprises at least one electric drive for movement purposes.

3. The welding unit of claim 2, wherein the joint arrangements are each operatively connected to the electric drive by means of at least one gearwheel.

4. The welding unit of claim 1, further comprising at least one guide means, which comprises at least one slotted guide, being configured to guide the welding means.

5. The welding unit of claim 1, wherein the at least one joint arrange comprises two joint arrangements which are arranged mirror-symmetrically with respect to one another, each joint arrangement comprising at least two articulated levers and the articulated levers of each joint arrangement being arranged in each case on a common shaft.

6. The welding unit of claim 5, further comprising a transport arrangement configured to transport a film tube which is to be welded and/or which has been welded and the transport arrangement being arranged at least partially in the course of the film tube above the welding means or below the welding means or on both sides (top and bottom) of the welding means.

7. The welding unit of claim 6, wherein the joint arrangements, in particular the articulated levers, are configured to move the transport means in an offset manner.

8. The welding unit of claim 7, wherein the transport arrangement comprises a two-part design and comprises a first transport means and a second transport means, the first transport means comprising at least one roller element and the second transport means comprising at least one roller element, the first transport means and the second transport means being movable relative to one another by means of at least one electric drive, in order to transport the film tube.

9. The welding unit of claim 8, wherein the transport means comprises a plurality of roller elements which are spaced apart from one another.

10. The welding unit of claim 8, the first transport means and the second transport means each being operatively connected to a respective electric drive by means of at least one gearwheel and the respective one electric drive being operatively connected to a respective joint arrangement.

11. The welding unit of claim 10, wherein each transport means comprises at least one angled retaining means, the angled retaining means of the transport means being arranged mirror-symmetrically with respect to one other.

12. The welding unit of claim 11, wherein the first transport means and the second transport means are each configured to be movable along the guide means, the guide means being of substantially dumbbell-shaped configuration and having a greater height at its respective end sections compared to a central section.

13. The welding unit of claim 1, further comprising at least one spring means is operatively connected to at least one welding means and is configured to generate a contact pressure on the film tube during the welding operation, the at least one spring means being configured as a tension spring or as a compression spring.

14. The welding unit of claim 1, further comprising at least two spring means, wherein each welding means is operatively connected to at least one of the at least two spring means in order to generate a contact pressure on the film tube during the welding operation.

15. The welding unit of claim 4, the joint arrangement(s) and the means for moving the joint arrangement(s) and preferably the guide means being coordinated with one another in such a way that the joint arrangement(s) can only be extended up to an angle of 189°, in particular exceedance of the dead center of the joint arrangement(s) is blocked.
